(19) United States
(12) Patent Application Publication
(10) Pub. No.: US 2005/0062180 A1
(43) Pub. Date: Mar. 24, 2005

(54) Method for making a plastic optical fiber, and resulting plastic optical fiber

(76) Inventors: Xavier Andrieu, Bretigny Sur Orge (FR); Bernard Boutevin, Montpellier (FR); Alain Pastouret, Les Ulis (FR); Alain Rousseau, Montpellier (FR); Jean-Marc Sage, Oullins (FR)

Correspondence Address: Joseph Sofer;Sofer & Haroun, 317 Madison Avenue, Suite 910, New York, NY, 10017, US

(21) Appl. No.: 10/496,100

(22) PCT Filed: Nov. 18, 2002
(86) PCT No.: PCT/FR02/03932

(30) Foreign Application Priority Data
Nov. 19, 2001 (FR) 01/15038

(51) Int. Cl. B29D 11/00

(52) U.S. Cl. 264/1.24; 264/2.1; 264/2.7

(57) ABSTRACT

The present invention concerns a method of manufacturing a plastic optical fiber from at least one polymer P, said method being characterized in that said polymer P is a copolymer comprising at least two repeating units P1 and P2 with the following general formulae, i and j corresponding to a repeat number of units: 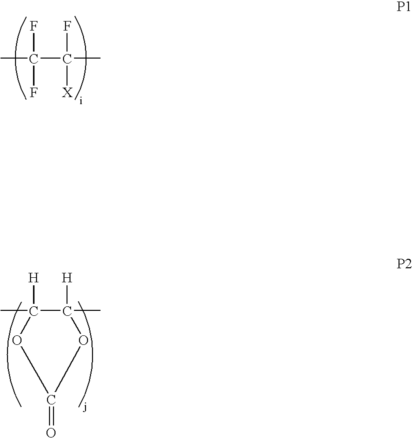 said copolymer P being transparent, amorphous in nature and having a motif P2 content in the range from substantially 30 mole % to 70 mole % when X═F or Cl in P1.

The present invention relates to a method of producing a plastic optical fiber and to a plastic optical fiber obtained by said method. It particularly relates to step index plastic optical fibers and to graded index plastic optical fibers.

Step index plastic optical fibers for use in a spectral range encompassing the visible and the near infrared, are advantageous since they are simpler to install than silica fibers because of their larger diameter. Graded index plastic optical fibers for use in the same spectral range are advantageous since they can be applied to broadband access networks. A graded index plastic optical fiber comprises at least one base polymer and a further compound, termed the “dopant”, comprising one or more monomers or polymers. The proportion of base polymer is substantially the same throughout the fiber and the proportion of dopant varies from the core to the periphery of the fiber so as to produce the desired gradient index or step index.

Such plastic optical fibers, in particular graded index plastic optical fibers, are difficult to manufacture, since the dopant must be present in a distribution that varies from the core to the periphery of a plastic optical fiber. In fact, the fiber has to have a refractive index profile that is graded in as regular a fashion as possible, with the variation in the refractive index between the center and the periphery of the fiber generally being in the range 0.01 to 0.03.

To manufacture such fibers, European patent EP-A-0 1 067 222 describes a method of manufacturing a graded index plastic optical fiber in which the index varies continuously between the center and the periphery of the fiber.

In that method, the fiber is manufactured from at least one polymer P and at least one reactive diluent D1, which acts as the dopant, allowing its refractive index to be varied.

That method comprises the following steps:
preparing two compositions with different refractive indices, the difference in refractive index between the two compositions being at least 5×10⁻³, each comprising at least the polymer P, one of the compositions, termed the first composition, also comprising at least the reactive diluent D1, a radical polymerization initiator being present in at least one of the compositions;
active mixing of the two compositions to obtain a continuous variation in the index of the optical fiber;
spinning the mixture;
curing the mixture to produce a plastic optical fiber with a refractive index gradient.

In accordance with that method, the polymer P and reactive diluent D1 are selected such that:
polymer P has a molar mass in the range 1000 to 20000 g.moles⁻¹ and the molar mass of the reactive diluent D1 is in the range 100 to 1000 g.moles⁻¹
the reactive diluent D1 comprises at least one UV-reactive unsaturated group selected from the group formed by vinyl groups and acrylic groups.

The molar masses mentioned above are number average molar masses. This is also the case with all of the molar masses mentioned below.

In the above-mentioned document, a preferred base polymer is of the poly (α-fluoro)methacrylate type, and more generally of the PMMA (polymethylmethacrylate) type.

Because of the high absorption of the C—H bonds in that polymer, applications for the fibers obtained from that polymer are limited to visible wavelengths less than 800 nanometers (nm).

Thus, the aim of the present invention is to provide a method of manufacturing a graded index optical fiber for producing plastic optical fibers that can function at wavelengths greater than 500 nm without causing prohibitive attenuation of the transmitted optical signal.

The present invention thus proposes a method of manufacturing a plastic optical fiber from at least one polymer P, said process being characterized in that said polymer P is a copolymer comprising at least two repeating units P1 and P2 with the following general formulae, i and j corresponding to a repeat number of units: 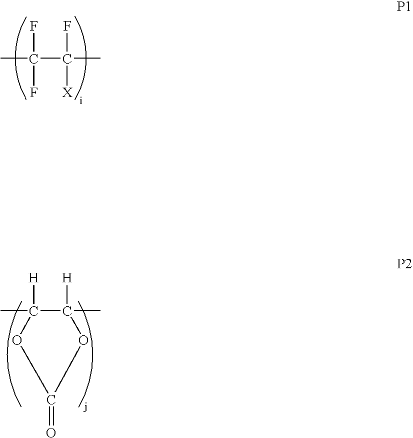
said copolymer P being transparent, amorphous in nature and having a quantity of motif P2 in the range from substantially 30 mole % to 70 mole % when X═F or Cl in P1.

The copolymer mentioned above, which has the optical and thermomechanical properties required for the manufacture of plastic optical fibers, said copolymer being colorless and transparent, soluble in the usual organic solvents (especially acetone, THF, ethyl acetate), with a glass transition temperature of more than 60° C., is used in known methods to produce plastic optical fibers, in particular graded index plastic optical fibers, with attenuation lower than that of the fibers obtained from prior art polymers.

The methods of the invention are applicable both to the manufacture of graded index optical fibers and to that of step index plastic optical fibers.

Copolymer P can be obtained from chlorotrifluoro-ethylene or tetrafluoroethylene, which are industrial fluorinated monomers, and vinylene carbonate, which is a readily available non-halogenated monomer.

The copolymer contains a great deal of fluorine and thus less hydrogen than prior art PMMA type polymers, resulting in increased transparency, and has a cyclic structure, resulting in an amorphous structure and thus in improved optical transmission properties. Thus, the fibers obtained by the method of the invention are particularly suitable for applications at wavelengths longer than 500 nm, typically in transmission windows around 650 nm, 850 nm, 1300 nm, and 1550 nm.

Highly advantageously, in a first implementation, the present invention proposes a method of manufacturing a step index plastic optical fiber of index that varies discontinuously between the center and the periphery of the fiber, or a graded index plastic optical fiber of index that varies continuously between the center and periphery of the fiber, from at least said polymer P and at least one reactive diluent D1 to vary the refractive index of said fiber, said method comprising the following steps:
preparing two compositions with different refractive indices, the difference in refractive index between the two compositions being at least 5×10⁻³, each comprising at least the polymer P, one of the compositions, termed the first composition, also comprising at least the reactive diluent D1, a radical polymerization initiator being present in at least one of the compositions;
spinning
curing the reactive diluent to produce a plastic optical fiber.

When the plastic optical fiber is a graded index fiber, said method also comprises, after the step for preparing said compositions, a step for active mixing of the two compositions to produce a continuous variation of the refractive index of the optical fiber, followed by spinning said mixture.

Advantageously, curing is photo-curing and the initiator is a photo-initiator.

Advantageously, the molar mass of the polymer P is in the range 1000 to 20000 g.moles⁻¹ and the molar mass of the reactive diluent D1 is in the range 100 to 1000 g.moles⁻¹. These ranges limit the viscosity of the composition and facilitate spinning.

Advantageously also, the reactive diluent D1 comprises at least one UV-reactive unsaturated group selected from the group formed by vinyl groups and acrylic groups.

The “active mixing” of the method of the invention is mixing carried out with assistance, i.e. it is not formed solely by diffusion; said active mixing can be produced statically, forcing mixing of the two compositions by a static diffusion means, usually by forced flow, or by a dynamic means which actively produces said mixing. Such a method has the advantage of being rapid, in fact far more rapid than if only diffusion between the compositions were to be employed, to produce a gradient of concentration and thus of refractive index which is continuous and practically regular.

The curing kinetics are generally such that, under maximum illumination and with complete initiator transformation, the gel time is less than 10 seconds (s), preferably less than 2 s.

In accordance with the method of the invention, spinning the graded index mixture is followed by photochemical or thermal curing of the diluent resulting in the production of a three-dimensional lattice. This method advantageously at least partially solidifies the components of the plastic optical fiber. The plastic optical fiber obtained and its index gradient is thus stable over time and also stable to temperature. In such a case, in general at least one of the two compositions comprises a monomer; further, at least one of the two compositions comprises at least one radical polymerization initiator, and preferably each of the two compositions comprises at least one radical polymerization initiator. The radical polymerization initiator is a compound which can generate initiator radicals by thermal or photochemical decomposition.

In one implementation, the second composition comprises at least one reactive diluent D2 that also allows its refractive index to be varied, the reactive diluent D2 having a refractive index that is substantially different from the refractive index of D1, having a molar mass in the range 100 to 1000 g.moles⁻¹, and comprising at least one UV-reactive unsaturated group selected from the group formed by vinyl groups and acrylic groups.

Preferably, the reactive diluents D1 and D2 have practically identical viscosities and the proportion by weight of polymer P with respect to the constituents of the composition is practically constant for each of the compositions. The method is easier to carry out as the variation in the proportion of reactive diluent(s) D1 and/or D2, principally enabling the refractive index to be modified, does not significantly influence the viscosity of the compositions.

In accordance with one implementation of the method of the invention, for a graded index optical fiber, the two compositions are mixed at a temperature such that the viscosity at 20° C. of each of the two compositions is in the range 1 pascal-second (Pa.s) to 25 Pa.s, preferably in the range 1 Pa.s to 15 Pa.s. This advantageously facilitates implementing the method of the invention, as said viscosity allows relatively fluid compositions to be mixed.

In accordance with one implementation of the method of the invention, spinning is carried out at a temperature such that the viscosity of each of the two compositions is more than 500 mPa.s, preferably more than 1000 mPa.s.

The reactive groups carried by constituents D1 and D2 are selected from the group formed by vinyl groups and acrylic groups, i.e. from acrylates, methacrylates, vinyl ethers and propenyl ethers; said compounds may be at least partially halogenated, usually fluorinated and/or chlorinated.

In one implementation of the method of the invention, every component of one of the compositions is an at least partially halogenated material, usually fluorinated and/or chlorinated.

In accordance with a variation of the method of the invention, in the case in which the reactive diluent D2 is present in the second composition, one of the two reactive diluents D1 or D2 is at least partially fluorinated and the other of the two reactive diluents D2 or D1 is at least partially chlorinated or chloro-fluorinated, and thus has a refractive index that is substantially higher than that of the at least partially fluorinated monomer.

In a second implementation, the present invention proposes a method of manufacturing a graded index plastic optical fiber the index of which varies continuously between the center and the periphery of the fiber, from at least said polymer P and at least one dopant D to vary the refractive index of said fiber, the refractive index of said dopant D being higher than that of said polymer P, said method comprising the following steps:
melting polymer P in a tube;
causing said tube to rotate about its axis;
cooling said tube to form a tubular body of polymer P inside said tube;
introducing said dopant D into said tubular body formed by the polymer P;
heating and causing said tube to rotate about its axis to thermally diffuse said dopant D through said polymer P and to form a tubular body of doped polymer P;
cooling to obtain a tubular pre-form;
drawing said tubular pre-form connected to a vacuum pump to form a plastic optical fiber.

In a third implementation, the present invention proposes a method of manufacturing a step index plastic optical fiber the index of which varies discontinuously between the center and the periphery of the fiber, from at least said polymer P, said polymer P being spun in the molten state and simultaneously coated with a photo-curing resin with a refractive index that is lower than that of the polymer P, which is then photo-polymerized.

Finally, in a fourth implementation, the present invention proposes a method of manufacturing a step index plastic optical fiber the index of which varies discontinuously between the center and periphery of the fiber, from at least said polymer P, by co-extruding said polymer P with a further polymer with a refractive index that is lower than that of said polymer P.

The method of the invention can clearly also be implemented to manufacture optical waveguides.

The present invention also provides a graded index plastic optical fiber obtained by the method of the invention, and an optical waveguide obtained by the method of the invention.

Other characteristics and advantages of the present invention become apparent from the following description of an implementation of the invention, given by way of non-limiting example.

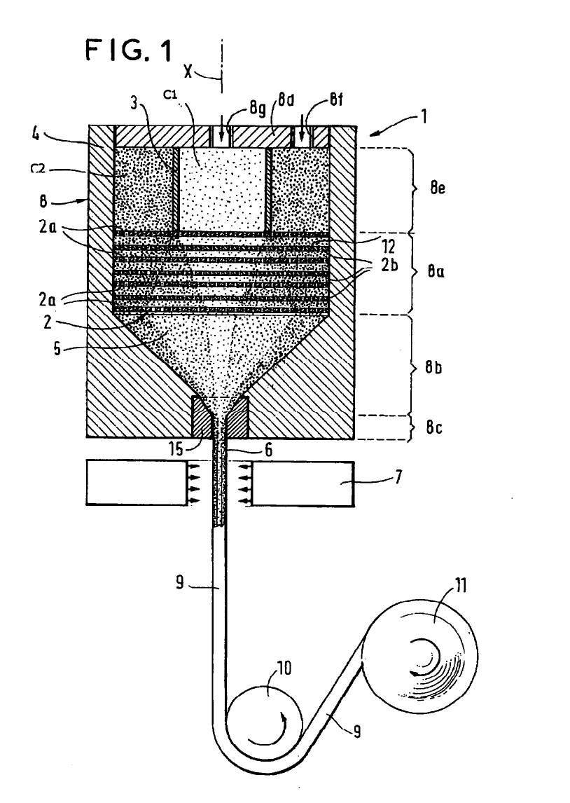

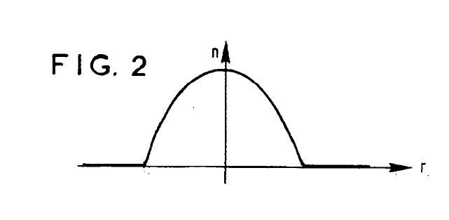

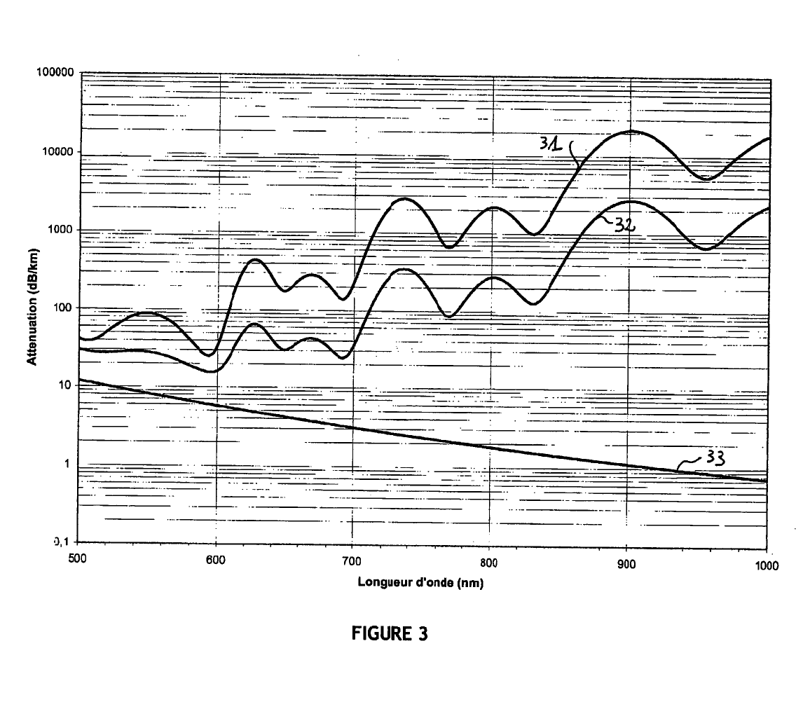

In the following figures:
FIG. 1 diagrammatically represents a device for implementing the method of the invention;
FIG. 2 diagrammatically represents an index profile for an optical fiber obtained using the device of FIG. 1;
FIG. 3 shows attenuation spectra for a graded index plastic optical fiber obtained from prior art methods and from a method according to one of the implementations of the invention.

In all of the figures, the common elements carry the same reference numerals.

In the method of the invention, two compositions are prepared, each comprising a copolymer P. One of said compositions also comprises at least one reactive diluent D1, which is preferably a monomer. Optionally, the other composition comprises at least one reactive diluent D2, which is preferably also a monomer. The concentration of D1 is different in each of the two compositions, which results in a different refractive index for each composition. The two values obtained for the refractive index constitute the maximum and minimum on the parabolic-shaped graph for the index gradient which is obtained for the plastic optical fiber obtained from the method (see FIG. 2).

The copolymer P used in the method of the invention is as defined above, i.e. comprising the repeating units P1 and P2 shown below.

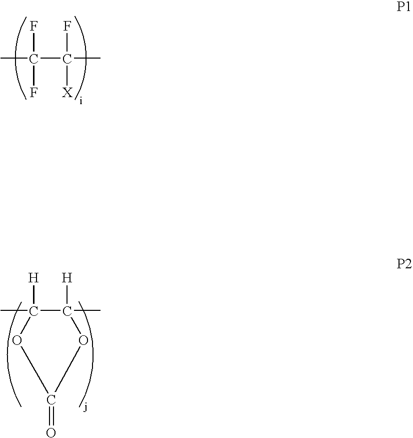

Unit P1 is derived from polymerizing i monomers M1 and unit P2 is derived from polymerizing j monomers M2.

Monomer M1 is a fluorinated monomer represented by the following general formula: CF₂═CFX, in which X is either:
a fluorine atom, in which case M1 is tetrafluoroethylene;
a chlorine atom, in which case M1 is chlorotrifluoroethylene.

The repeating entities P1 can be derived from a mixture of monomers with formula M1.

The co-monomer M2 giving rise to repeating units P2 is vinylene carbonate with the following formula:

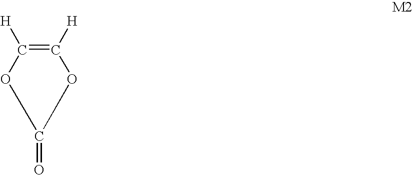

Any known polymerization method of producing polymer P can be employed: solvent polymerization, suspension polymerization or emulsion polymerization in water, for example. Generally, it is preferable to operate in a solvent to control the exothermic nature of the polymerization and encourage intimate mixing of the different monomers.

Examples of routinely used solvents that can be cited are: ethyl, methyl or butyl acetate, and chlorinated or chlorofluorinated solvents such as F141b® (CFCl₂—CH₃) or F113® (CF₂Cl—CFCl₂).

The radical polymerization initiator used can be a free radical generator such as a peroxide, hydroperoxide or percarbonate, or a diazo compound such as azobis-isobutyronitrile (AIBN). When the method is carried out in an aqueous medium, it is possible to use inorganic free radical generators such as persulfates, or redox combinations.

The polymerization temperature is generally dictated by the rate of decomposition of the selected initiator and is generally between 0° C. and 200° C., more particularly between 40° C. and 120° C.

The pressure is generally in the range from atmospheric pressure to a pressure of 50 bars, more particularly in the range 2 bars to 20 bars.

To allow better control of the composition of copolymer P, it is also possible to introduce all or part of the monomers as well as the polymerization initiator in a continuous manner or in fractions during polymerization.

The copolymer P used in the method of the invention has a glass transition temperature (Tg) between 60° C. and 160° C., preferably between 80° C. and 140° C. This glass transition temperature is principally linked to the quantity of motifs P2 present in the copolymer. The transparency of the polymer obtained also depends on the quantity of motifs P2.

The quantity of motif P2, the repeating unit derived from polymerizing monomers M2, can vary in the copolymer as a function of the nature of X in P1. When X═F or Cl in P1, the quantity of motif P2 is the copolymer is substantially in the range 30 mole % to 70 mole %.

Without prejudice to the invention, it is also possible to introduce a third monomer during polymerization provided that its quantity remains less than 15 mole % in the copolymer formed.

Polymer P of the method of the invention has a molar mass (Mn) in the range 500 to 10⁶ g.moles⁻¹, preferably in the range 10³ to 10⁴ g.moles⁻¹.

The invention will now be illustrated in the following examples of the production of copolymer P.

The reagents, initiators and solvents used have the following abbreviations:
CTFE: Chlorotrifluoroethylene CF₂═CFCl
TFE: tetrafluoroethylene CF₂═CF₂
VCA: vinylene carbonate
TBPP: Tertiobutyl perpivalate, 75% by weight in isododecane
F141b®: 1,1,1-dichlorofluoroethane

The Mn values (number average molar masses) were determined by SEC (steric exclusion chromatography). A “Winner Station” apparatus from Spectra Physics was used. Detection was by refractive index. The column used was a 5 micron mixed C PL gel column from Polymer Laboratories and the solvent used was THF at a flow rate of 0.8 ml/min. The number average molar masses (Mn) are expressed in g.moles⁻¹ with respect to a polystyrene standard.

Tg (glass transition temperature) was determined by differential scanning calorimetry (DSC). The temperature was initially raised at 20° C./min followed by cooling, then the temperature was raised a second time during which the Tg or Tf (melting temperature) was read. The temperature range was 50° C. to 200° C. if Tg was greater than 60° C.

The chlorine content was determined conventionally by mineralization in a PARR bomb with Na₂O₂, then assaying the chlorides by argentometry.

### EXAMPLE 1

### M1/M2: CTFE/VCA

A 160 milliliter (ml) stainless steel reactor was used, purged two or three times at 5 bars of nitrogen. 50 ml of a solution of F141b® containing 0.6 ml of TBPP initiator (2.25 mmoles) and 8.53 g of VCA (99 mmoles) was then introduced into the evacuated reactor (pressure about 100 mbars) by aspiration. 11 g of CTFE (94.5 mmoles) was then introduced. The reaction medium was heated to 80° C. for 2 hours (h) 30 minutes with stirring, with an initial pressure of about 10 bars. After the reaction, the contents of the autoclave were partially evaporated, precipitated with heptane then vacuum dried. 16.2 g of a copolymer that was soluble in the usual solvents (acetone, THF) was obtained. Analyses carried out on the copolymer obtained in Example 1 indicated a mole ratio P1/P2 of 47/53, a Mn of 7400 g.moles⁻¹ and a Tg of 120° C. A transparent colorless film was obtained on dissolving in ethyl acetate and evaporation.

### EXAMPLE 2

### M1/M2: CTFE/VCA

The procedure of Example 1 was followed, using the same reagents and the same proportions, using ethyl acetate as the solvent instead of F141b®. At the end of the reaction, a solution of a polymer in ethyl acetate was obtained. The solvent was evaporated to obtain a volume of about 20 ml, then the reaction product was precipitated using n-heptane. The precipitated polymer was filtered then vacuum dried at 60° C. 10 g of a transparent, colorless copolymer was obtained which was soluble in THF or acetone. The mole ratio P1/P2 was 49/51 and Tg was 106° C.

1 g of this copolymer was removed and dissolved in 3 ml of ethyl acetate. The solution obtained was completely clear. This solution was deposited in a 7 centimeter (cm) flat crystallizer and the solvent was evaporated over 3 days at ambient temperature and atmosphere. The film obtained was completely transparent and clear.

### EXAMPLES 3 to 7

For comparative Examples 3, 5, 6 and 7 as well as Example 4, the procedure of Example 2 was followed, using the quantities of reagents CTFE and VCA indicated in Table 1 below.

The comparative examples shown in Table 1 used x mmoles of CTFE and y mmoles of VCA, x and y having the following values:
Example 1: x=94.5 and y=99;
Example 2: x=95 and y=98;
Comparative Example 3: x=186 and y=40;
Example 4: x=86 and y=174;
Comparative Example 5: x=181 and y=10.5;
Comparative Example 6: x=43 and y=174;
Comparative Example 7: x=0 and y=180.

The mole ratios P1/P2, the yield of polymer obtained as a mole %, the appearance of the solution of the polymer obtained from the polymerization reaction of M1 and M2 and the appearance of the film of said polymer are shown in Table 1 for Examples 1 to 7.

TABLE 1

| | Mole | | | |
|---|---|---|---|---|
| | percentage | | | Observations |
| | P1/P2 | Yield | Appearance of | concerning the |
| Example | (1) | (%) | solution (2) | film obtained |
| 1 | 47/53 | # | Clear | Transparent |
| | | | | Tg 120° C. |
| 2 | 49/51 | 51% | Clear | Transparent |
| | | | | Tg 106° C. |
| 3 | 85/15 | 28% | Clear | Transparent |
| | | | | Tg < 50° C. |
| 4 | 33/67 | 49% | Clear | Transparent |
| 5 | 95/5 | 5% | Clear | Opalescent |
| 6 | 20/80 | 60% | Many | Transparent + opaque |
| | | | insolubles | insolubles |
| | | | present | |
| 7 | 0/100 | 70% | Presence of | Opaque insolubles |
| | | | insolubles | |

(1) P1 with CTFE co-monomer M1, and P2 with VCA co-monomer M2.
(2) Solution: 1 g of polymer in 3 ml of ethyl acetate.

It can be seen that for Examples 1, 2 and 4 comprising mole ratios P1/P2 substantially in the range 70/30 to 30/70 with M1=CTFE and M2=VCA, the solution of copolymer P obtained was clear and the film of copolymer obtained after evaporating the solvent from said solution was a transparent solid. It can be seen in the case of comparative examples 3, 5, 6 and 7 with mole ratios P1/P2 located outside the range cited above, the film of copolymer was a non-transparent solid.

### EXAMPLE 8

### M1/M2: TFE/VCA

The procedure of Example 2 was followed, but using 7 g 81.3 nmoles) of VCA and 11 g (110 mmoles) of TFE instead of CTFE. 14.6 of copolymer was obtained. The copolymer was highly soluble in acetone or THF. On evaporating off the acetone, a transparent colorless film was obtained. ¹⁹F NMR analysis indicated a mole ratio P1/P2 of 70/30. The Tg of the copolymer was 82° C. (DSC analysis).

Other tests were also carried out with M1=TFE and M2=VCA. It was shown that for mole ratios P1/P2 substantially in the range 70/30 to 30/70, substantially transparent copolymer films were obtained.

Once the copolymer P had been obtained, for example using one of the examples described above, the two compositions C1 and C2 were prepared to produce an optical fiber in accordance with the invention by a UV type method.

Two different compositions were manufactured, comprising a commercial photo-initiator, the reactive copolymer P of Example 1, 2 or 3 above, and a reactive diluent composed of two monomers in different proportions depending on the composition, the two monomers being (D1) and (D2).

The photo-initiator could, for example, be a (α-hydroxyketone (IRGACURE 184, DAROCUR 1173), a mono-acyl phosphine (DAROCUR TPO) or a bis-acyl phosphine (IRGACLURE 819).

D1 and D2 could be monomers having at least one acrylic, methacrylic, α-fluoroacrylic, α, β-difluoroacrylic or vinyl function comprising halogenated groups (fluorinated and chlorinated).

Table 2 below shows the constitution and properties of compositions C1 and C2 prepared by mixing the reactive copolymer P of Example 1, the reactive diluent D1 being trifluoroethyl acrylate (the homopolymer of which has a refractive index of 1.407 at 20° C.) and the reactive diluent D2 being trifluoroethyl methacrylate (the homopolymer of which has a refractive index of 1.437 at 20° C.). The photo-initiator was from the bis-acyl phosphine class (BAPO-IRGACURE 819). The quantities are calculated for 700 grams of composition.

TABLE 2

| | Quantity of D1 | Quantity of D2 | Quantity of P |
|---|---|---|---|
| Composition | (g) | (g) | (g) |
| C1 | 35 | 315 | 350 |
| C2 | 140 | 210 | 350 |

It can be seen that the ratio, as a % by weight, of the copolymer P to the sum of the constituents of each composition was constant, while in the reactive diluent the relative proportion, as a % by weight of D1 with respect to the sum of D1 and D2, varied from one composition to the other. This allowed the viscosity of the two compositions to be controlled by varying the refractive index of each of said compositions.

According to the method of the invention, to produce a graded index fiber, the continuous index variation was created by active mixing of the two starting compositions C1 and C2. To this end, the method of the invention was implemented using a mixing means which could be a static or dynamic mixer. This implementation is explained in detail in EP-A-1 067 22 which is hereby incorporated by reference. No further details will be given here of the function of the static or dynamic mixer used in the method of the invention, and it will be sufficient simply to describe the method of the invention in its implementation using one of the static mixers described in EP-A-1 067 222.

FIG. 1 shows a highly diagrammatic cross section along a plane comprising a central axis X of a device for manufacturing an optical fiber in accordance with the method of the invention.

Device 10 comprises a static mixer 1. Compositions C1 and C2 of the table above were mixed therein.

Mixer 1 comprises two concentric cylinders 3 and 4 acting as reservoirs for compositions C1 and C2. Cylindrical chamber 8 of the mixer 1 acts as a reservoir 4 for the composition C2. Composition C1 with the higher refractive index is placed in the central reservoir 3.

Chamber 8 comprises an upper leak-proof closure 8d which comprises two respective inlets 8g and 8f that provide a controlled pressure in each of respective reservoirs 3 and 4, for example using two volumetric pumps (not shown). A controlled pressure can thus be applied to the two compositions C1 and C2 to obtain an identical flow if the two compositions C1 and C2 have the same viscosity. It is also possible, however, to apply different controlled pressures for the openings 8f and 8g, for example if a different flow for each composition C1 or C2 is desired in the case of two compositions C1 and C2 with different viscosities. The chamber 8 also comprises a zone 8e in which the two reservoirs 3 and 4 are concentric, isolated one from the other, and a zone 8a the upper limit of which is the bottom of the central reservoir 3 and the lower limit of which is the bottom of the peripheral reservoir 4. The zone 8a corresponds to a mixing zone for the two compositions C1 and C2 by the mixer 1, namely an assembly 2 of superimposed plates (2a, 2b) perforated with holes 12. The chamber 8 also comprises a conical zone 8b in which a homothetic variation of cross section occurs, and finally a graded zone 8c comprising a die 15, which provides the desired order of magnitude for the diameter of the graded index plastic optical fiber 6 obtained. The die 15 is an attached part, which means that its grade can readily be changed without changing the mixer 1.

Zone 8a of the mixer 1 comprises at least two, and in this case seven, perforated plates (2a, 2b) superimposed one above the other. This assembly 2 of plates (2a, 2b) is placed at the lower end of the central reservoir 3 to ensure radial mixing of compositions C1 and C2. A mixture 5 is obtained in zone 8a which has a gradient of concentrations of compositions C1 and C2. The mixture 5 is formed because of the superimposition of the plates (2a, 2b). Each plate 2a (or 2b) comprises holes 12, generally disposed counter to one another from one plate 2a to a neighboring plate 2b (or from one plate 2b to a neighboring plate 2a). In the representation of FIG. 1, there are two types of plates, plates 2a, four in number, and plates 2b, three in number, each of plates 2a or 2b comprising approximately the same number of holes 12.

The mixture 5 obtained is brought to the graded die 15 of zone 8c of the chamber 8 via the conical zone 8b the upper limit of which is the lower end of the last plate 2a. This homothetic variation preserves the shape of the concentration variation of compositions C1 and C2.

At the outlet from the die 15, the filament obtained, which is a graded index plastic optical fiber, 6, is drawn by a capstan 10. In one embodiment, the plastic optical fiber 6 is cured by photo-curing using a source 7 of ultraviolet radiation (UV) into a polymerized plastic optical fiber 9. The plastic optical fiber 9 is then wound onto a bobbin 11 using the capstan 10. The diameter of the fiber 9 is given by the die 15, but it may be made thinner depending on the draw force produced by the capstan 10. Either plastic optical fiber 6 or 9 can be used as the finished product of the invention.

FIG. 2 shows a diagram of an index profile obtained for an optical fiber manufactured using the device of FIG. 1. The refractive index profile n of the optical fiber 6 of FIG. 1 is shown, and is practically smooth so that it forms a gradient which is parabolic in shape, a function of the distance r from the center of the fiber 6, which is on the axis X.

The fiber obtained is thus a graded index fiber, but the method above can also allow a step index fiber to be obtained. In that case, active mixing of compositions C1 and C2 is not carried out. C1 and C2 are introduced into a distributor can extended by a die, where the final diameter of the fiber and the proportion of core to cladding are governed by the pressure and temperature of compositions C1 and C2 as well as the diameter of the die.

The present invention also concerns other type of methods for producing plastic optical fibers.

To manufacture a graded index plastic optical fiber, it is possible to use a method as described in U.S. Pat. No. 6,071,441, termed a pre-form method.

In one example of an implementation, to manufacture the pre-form, 100 g of CTFE/VCA copolymer type polymer P wherein the molar proportion of the CTFE motif is between 30% and 70% with a mass average molar mass of about 5×10⁵ are melted at a temperature in the range 200° C. to 250° C. in a cylindrical glass tube, without filling it entirely, so that a vacant space is produced in the tube containing the polymer P before sealing it under vacuum. The glass tube is then placed in a horizontal position in an oven. It is then rotated about its horizontal axis (the speed was fixed at 2000 rotations/minute), and the oven was heated to a temperature such that the viscosity of the molten polymer P was in the range 10³ to 10⁵ poise, for three hours. The tube was then cooled slowly over one hour. The tubular body obtained had an external diameter of 17 mm and an internal diameter of 5 mm, and its refractive index was 1.45.

A dopant D was then introduced into the central portion of said tubular body, still inside the glass, tube. Its proportion was 4% by weight with respect to the polymer P. So that the dopant is adapted to the material used, it is preferable for it to satisfy the two following conditions:
its refractive index n is higher than that of polymer P;
the difference in the solubility parameters of polymer P and dopant D, |δp-δ_{D}|, is 7 or less (cal/cm³)^{1/2}.

Table 3 below summarizes several examples of compounds that could be used as a dopant D for this application.

TABLE 3

| Dopant D | n | δ(cal/cm³)^{1/2} |
|---|---|---|
| n-butyl benzyl phthalate | 1.575 | 9.64 |
| 1-methoxyphenyl-1-phenylethane | 1.571 | 9.74 |
| benzyl benzoate | 1.568 | 10.7 |
| bromobenzene | 1.557 | 9.9 |
| o-dichlorobenzene | 1.551 | 10.0 |
| m-dichlorobenzene | 1.543 | 9.9 |
| 1,2-dibromoethane | 1.538 | 10.4 |
| 3-phenyl-1-propanol | 1.532 | 11.4 |

The ensemble was rotated again in an oven. Dopant D diffused thermally through the molten polymer P in 6 hours. Finally, the oven was slowly cooled at a rate of 15° C./hour to ambient temperature. A tubular body with an external diameter of 17 mm and an internal diameter of 4.5 mm was obtained with a refractive index gradient.

This tubular body, constituting the pre-form for the graded index plastic optical fiber, was placed in a drawing oven at a temperature in the range 200° C. to 250° C. Its upper portion was connected to a vacuum pump during the spinning step. In this manner, the pre-form shrank and an optical fiber with a refractive index gradient was recovered. Its dimensions depended on the rate of spinning, preferably in the range 5 to 10 m/min, and on the oven temperature.

Advantageously, the use of polymers P of the invention having a glass transition temperature that is higher than those of PMMA or CYTOP, materials which are conventionally used in the known “pre-form” method produces fibers with higher transparency than those obtained with conventional materials. This is illustrated in FIG. 3, which shows, as a function of the wavelength in nm, the attenuation (in dB/km) of a graded index plastic optical fiber obtained using the method described above, from prior art polymer CYTOP (curve 31), prior art polymer PMMA (curve 32) and the (CTFE)0.50 (VCA)0.50 of the invention (curve 33).

To manufacture the step index plastic optical fibers of the invention, a polymer P of the invention produced, for example, as described in one of the above examples, can be spun in the molten state with simultaneous deposition of a photo-curing resin with a refractive index that is lower than that of the polymer P, said resin then being photo-polymerized. The thickness of the resin layer deposited was of the order of 100 μm, for example.

Alternatively, to manufacture a step index plastic optical fiber of the invention, it is possible to proceed by co-extruding the polymer P with a polymer with a refractive index that is lower than that of the polymer P, such as PVDF, Teflon®AF from Pont de Nemours or Hyflon AD® from AUSIMONT.

The last two methods mentioned are well known per se to the skilled person and will not be described in further detail here.

Clearly, the method of the invention is not limited to the implementations that have been described above.

It is possible to use any device that is suitable for producing active mixing as the device for carrying out the UV method of manufacturing graded index optical fibers, in particular but not exclusively the devices described in document EP-A-1 067 222.

Further, the above compositions and examples are given by way of indication only, and the scope of the invention encompasses modifying them provided that the copolymer P retains the general characteristics mentioned above.

Finally, the scope of the invention encompasses replacing any means by any equivalent means.

1. A method of manufacturing a plastic optical fiber from at least one polymer P, said method comprising the steps of:
making a polymer P wherein [process being characterized in that] said polymer P is a copolymer [comprising] having at least two repeating units P1 and P2 with the following general formulae, i and j corresponding to a repeat number of units: 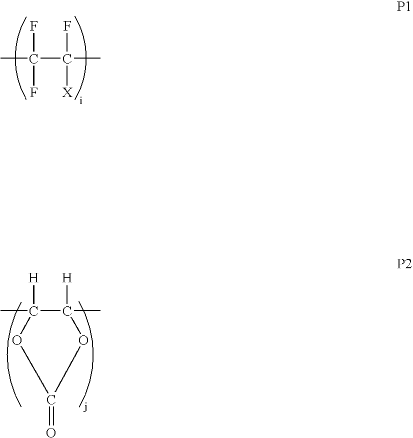
said copolymer P being transparent, amorphous in nature and having a quantity of motif P2 in the range from substantially 30 mole % to 70 mole % when X═F or Cl in P1.

2. A method according to claim 1 for manufacturing a step index plastic optical fiber., the refractive index of which varies discontinuously between the center and the periphery of the fiber, or a graded index optical fiber, the index of which varies continuously between the center and periphery of the fiber, from at least said polymer P and at least one reactive diluent D1 to vary the refractive index of said fiber, said method further comprising the steps of:
preparing two compositions with different refractive indices, the difference in refractive index between the two compositions being at least 5×10⁻³, each comprising at least the polymer P, one of the compositions, termed the first composition, also comprising at least the reactive diluent D1, a radical polymerization initiator being present in at least one of the compositions;
spinning; and
curing the reactive diluent to produce a plastic optical fiber.

3. A method according to claim 2, wherein when the plastic optical fiber is a graded index fiber, said method further comprises the step of, after the step for preparing said compositions, a step for active mixing of the two compositions to produce a continuous variation of the refractive index of the optical fiber, followed by spinning said mixture.

4. A method according to claim 2, wherein said curing is photo-curing and in that said initiator is a photo-initiator.

5. A method according to claim 2, wherein the molar mass of the polymer P is in the range 1000 to 20000 g.moles⁻¹ and the molar mass of the reactive diluent D1 is in the range 100 to 1000 g.moles⁻¹.

6. A method according to claim 2, wherein the reactive diluent D1 comprises at least one UV-reactive unsaturated group selected from the group formed by vinyl groups and acrylic groups.

7. A method according to claim 2, wherein the glass transition temperature of said copolymer is in the range 60° C. to 160° C.

8. A method according to claim 2, wherein the molar mass of said copolymer is in the range 500 to 10⁶ g.moles⁻¹.

9. A method according to claim 2, wherein the curing kinetics are such that, under maximum illumination and with complete transformation of the initiator, the gel time is less than 10 seconds.

10. A method according to claim 9, wherein the gel time is less than 2 seconds.

11. A method according to claim 2, wherein the second of said compositions comprises at least one reactive diluent D2 allowing its refractive index to be varied, the reactive diluent D2 having a substantially different refractive index from the refractive index of D1, having a molar mass in the range 100 to 1000 g.moles⁻¹ and comprising at least one UV-reactive unsaturated group selected from the group formed by vinyl groups and acrylic groups.

12. A method according to claim 11, wherein the viscosities of the reactive diluents D1 and D2 are substantially identical and in that the proportion by weight of said polymer P with respect to the constituents of the composition is substantially constant for each of said compositions.

13. A method according to claim 3, wherein the two compositions are mixed at a temperature such that the viscosity at 20° C. of each of said compositions is in the range 1 to 25 Pa.s.

14. A method according to claim 2, wherein said spinning is carried out at a temperature such that the viscosity of each of the two compositions is more than 500 mPa.s.

15. A method according to claim 2, wherein every component of one of said compositions is an at least partially halogenated material.

16. A method according to claim 15, wherein when the reactive diluent D2 is present in the second of said compositions, one of the two reactive diluents D1 or D2 is at least partially fluorinated and the other of the two reactive diluents D2 or D1 is at least partially chlorinated or chlorofluorinated.

17. A method according to claim 1 for manufacturing a graded index plastic optical fiber., the index of which varies continuously between the center and the periphery of the fiber, from at least said polymer P and at least one dopant D to vary the refractive index of said fiber, the refractive index of said dopant D being higher than that of said polymer P, said method further comprising the steps of:
melting polymer P in a tube;
causing said tube to rotate about its axis;
cooling said tube to form a tubular body of polymer P inside said tube;
introducing said dopant D into said tubular body formed by the polymer P;
heating and causing said tube to rotate about its axis to thermally diffuse said dopant D through said polymer P and to form a tubular body of doped polymer P;
cooling to obtain a tubular pre-form; and
drawing said tubular pre-form connected to a vacuum pump to form a plastic optical fiber.

18. A method according to claim 1 for manufacturing a step index plastic optical fiber., the index of which varies discontinuously between the center and the periphery of the fiber, from at least said polymer P, said polymer P being spun in the molten state and simultaneously coated with a photo-curing resin with a refractive index that is lower than that of the polymer P, which is then photo-polymerized.

19. A method according to claim 1 for manufacturing a step index plastic optical fiber., the index of which varies discontinuously between the center and periphery of the fiber, from at least said polymer P, by co-extruding said polymer P with a further polymer with a refractive index that is lower than that of said polymer P.

20. A step index or graded index plastic optical fiber, wherein said step index or graded index plastic optical fiber is obtained by the method according to claim 1.

21. An optical waveguide, wherein said optical waveguide is obtained by the method according to claim 1.

22. An optical waveguide, wherein said optical waveguide is obtained by the method according to claim 20.
